(19) United States
(12) Patent Application Publication
(10) Pub. No.: US 2009/0260358 A1
(43) Pub. Date: Oct. 22, 2009

(54) Thermoelectric Energy Conversion System

(75) Inventors: John W. Rapp, Manassas, VA (US); Robert James Howard, Clifton, VA (US); Nicholas J. Nagurny, Manassas, VA (US); Natalie Levings, Palm Beach Gardens, FL (US); Lance Greer, Nokesville, VA (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/411,824

(22) Filed: Mar. 26, 2009

Related U.S. Application Data
(60) Provisional application No. 61/042,185, filed on Apr. 3, 2008.

(51) Int. Cl. F03G 7/05; F01K 7/38; H01L 35/00

(52) U.S. Cl. 60/641.7; 60/670; 62/3.2; 136/205

(57) ABSTRACT

A system for generating electrical energy using a naturally occurring temperature difference is disclosed. The system provides electrical energy by thermally coupling a conduit that conveys hot material from a petroleum reserve and cold deep-level water to opposing sides of a thermoelectric element. The thermoelectric element generates electrical energy based on the temperature difference between these two surfaces.

### CROSS REFERENCE TO RELATED APPLICATIONS

This case claims priority to: U.S. Provisional Patent Application Ser. No. 61/033,415, filed Mar. 3, 2008 (Attorney Docket: 711-136US); and U.S. Provisional Patent Application Ser. No. 61/042,185, filed Apr. 3, 2008 (Attorney Docket: 711-189US); each of which is incorporated by reference.

If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to energy systems in general, and, more particularly, to geothermal energy systems.

### BACKGROUND OF THE INVENTION

Off-shore operations platforms, such as petroleum production platforms, radar installations, and the like, require a local power source to enable operation of pumps, electrical equipment, life support, cranes, off-loading equipment, etc. Typically, local power is provided through the use of one or more diesel generators. Unfortunately, diesel generators generate pollution due to exhaust, oil leaks, etc. Further, diesel generators require significant routine maintenance and repair, which increases their operating expense.

Non-petroleum-based energy conversion systems are attractive alternative local power sources for off-shore installations. Systems such as geothermal energy conversions systems and Ocean Thermal Energy Conversion (OTEC) systems can provide electrical energy through the exploitation of a naturally occurring temperature differential. A conventional geothermal system exploits the temperature differential between a naturally-occurring hot spot below the earth's surface and the ambient temperature at the location of the geothermal system. OTEC systems exploit a temperature differential between the temperature of ocean water at some depth (e.g., >1000 meters) and the temperature of water at the ocean's surface.

Geothermal systems have been in operation for many years. A conventional geothermal system typically uses a gas-driven turbine to turn an electrical generator. The electrical generator, in response, provides output electrical energy. The blades of the turbine are driven by either hot gas that come directly from the geothermal heat source or working fluid that is vaporized by the hot gas at a heat exchanger.

There are several problems with conventional geothermal systems that have thus far limited their use. First, the hot gas from the geothermal source is highly corrosive. As a result, the lifetime of the turbine and other system components can be compromised. Second, atmospheric temperature acts as the heat sink for conventional geothermal systems. The power generation capacity of a conventional geothermal system decreases as the ambient temperature at the turbine increases. This is due to the fact that the power generation is directly related to the temperature differential of the system. To further exacerbate matters, the reduction in power generation capacity tends to occur at times when such power is needed most (e.g., when it is hot out and air conditioning demand increases, etc.) Further, latitude and seasonal temperature variation cause variability in the power generation capability of these systems.

In a typical OTEC system, electrical energy is also generated by a generator that is driven by a turbine. The turbine is driven by means of a heat engine that forces vapor forced across its blades. The heat engine results from the temperature differential between deep ocean water and surface water. Conventional OTEC systems can either be open-cycle or closed-cycle. In an open-cycle system, warm seawater is placed into a low-pressure container, wherein it boils and creates steam that drives the blades of the turbine. In closed-cycle system, warm surface seawater is pumped through a heat exchanger where its heat vaporizes a working fluid that drives the turbine blades.

Conventional OTEC systems also have several problems in practice. Like geothermal systems, latitude and seasonal temperature variations cause variation in the power generation capability of OTEC systems. In addition, the daily solar cycle induces minor variations in the temperature of the uppermost surface seawater. Further, hurricanes and tropical storms can reduce surface water temperatures, and weather can obstruct sunlight, thereby blocking the natural source of surface heating; and strengthening the winds, thereby increasing the loss of surface heat via water evaporation into the atmosphere.

In addition, the thermal efficiency of an OTEC system is a function of the temperature differential between its heat source (e.g., warm surface water) and its heat sink (e.g., cold deep ocean water). The relatively small temperature difference between surface water and deep water, which is typically relied upon in a conventional OTEC system, generally limits thermal efficiency to a maximum of only a few percent.

### SUMMARY OF THE INVENTION

The present invention provides an energy generation system based on a temperature differential between a petroleum product being pumped from a petroleum reservoir and cold water in a deep water region. Some embodiments of the present invention are particularly well-suited for power generation at off-shore petroleum production platforms.

In some embodiments, an energy generation system comprises an energy conversion unit that includes a first heat exchanger, a second heat exchanger, and a Rankine-cycle engine that generates electrical energy based on a temperature difference between the two heat exchangers. In these embodiments, a closed-loop fluid system thermally couples a hot petroleum product in an extraction conduit and a working fluid at the first heat exchanger. The working fluid and cold water from a deep water region are thermally coupled at the second heat exchanger. Preferably, the deep-water layer exhibits a high heat capacity and a temperature that is substantially constant regardless of latitude, weather conditions, the annual solar cycle, or even the daily solar cycle. The Rankine-cycle engine interposes the first heat exchanger and the second heat exchanger.

In some embodiments, an energy generation system comprises an energy conversion unit that includes a first heat exchanger, a second heat exchanger, and a thermoelectric element. The thermoelectric element converts a temperature gradient across its thickness into electrical energy. In these embodiments, hot petroleum product in an extraction conduit and a first surface of the thermoelectric element are thermally coupled at the first heat exchanger. A cold zone and a second surface of the thermoelectric element are thermally coupled at the second heat exchanger. The cold zone is thermally coupled to cold water from a deep water region so that the temperature of the cold zone remains relatively low and constant. The thermoelectric system interposes the first heat exchanger and the second heat exchanger.

In addition to generating electrical energy without significant negative environmental impact, in some of these embodiments the temperature of the petroleum product is advantageously reduced by virtue of the present invention. As a result, the crude oil and/or natural gas is made less corrosive. This obviates the need for using expensive corrosion suppression technology within the oil/gas production equipment and facility.

An embodiment of the present invention comprises: an energy conversion unit, wherein the energy conversion unit comprises; a hot zone, wherein the hot zone and a conduit are thermally coupled; and a cold zone that is thermally coupled to a region of a body of water; and an energy conversion system that generates electrical energy based on a temperature difference between the hot zone and the cold zone; wherein the conduit conveys a petroleum product from a petroleum reserve.

### BRIEF DESCRIPTION OF THE DRAWINGS

FIG. 1 depicts a representative ocean-based petroleum production system in accordance with the prior art.

FIG. 2 depicts a schematic diagram of a portion of a representative OTEC power generation system in accordance with the prior art.

FIG. 3 depicts a schematic diagram of details of an off-shore petroleum production system in accordance with an illustrative embodiment of the present invention.

FIG. 4 depicts a schematic diagram of details of energy conversion system 302.

FIG. 5 depicts a method for powering an off-shore petroleum production system in accordance with the illustrative embodiment of the present invention.

FIG. 6 depicts a schematic diagram of details of an energy conversion system in accordance with an alternative embodiment of the present invention.

### DETAILED DESCRIPTION

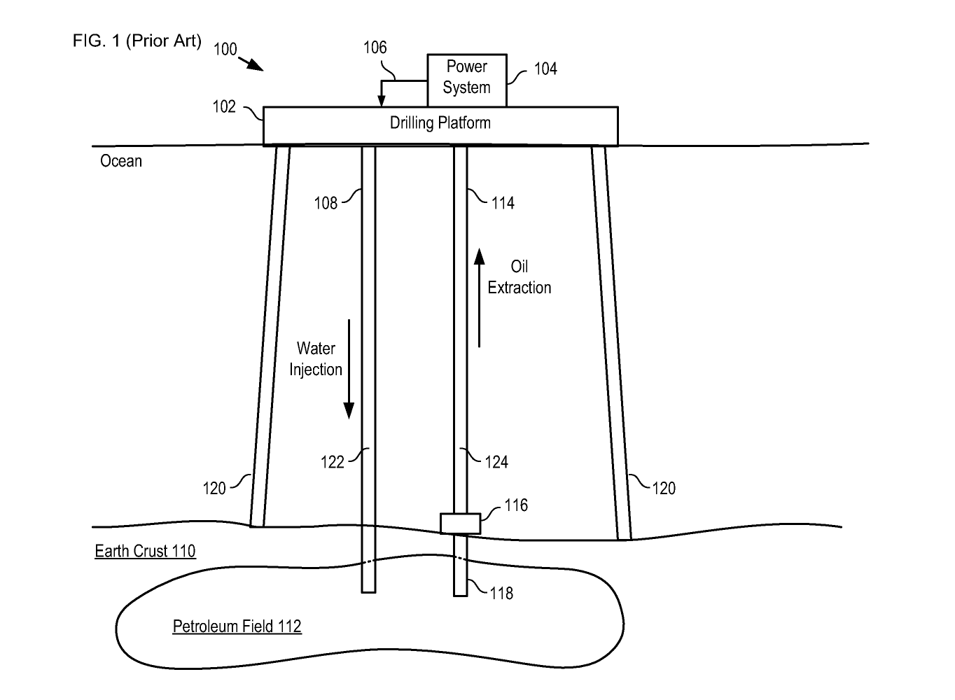

FIG. 1 depicts a representative ocean-based petroleum production system in accordance with the prior art. System 100 comprises tension-leg platform 102, power system 104, injection conduit 108, extraction conduit 114, and well head 116. System 100 is representative of floating installations that are widely used in deep-water areas to extract petroleum products, such as oil, natural gas, and the like, from sub-terranean petroleum fields.

Drilling platform 102 is a conventional “tension-leg” petroleum production facility. It normally comprises pumps, control equipment, drills, cranes, docking facilities, storage tanks, off-loading equipment, etc. Drilling platform is supported above the ocean floor by tension legs 120.

Power system 104 is an electrical energy generation system that provides electrical energy to drilling platform 102 on power cable 106. The generated electrical energy is used to run pumps, cranes, electrical systems, life support systems refrigeration, and the like. Typically, power system 104 is a conventional generator powered by an internal combustion engine, such as a diesel motor.

Injection conduit 108 is a long (often several kilometers) metal pipe that typically has a diameter within the range of 10 centimeters (cm) to 30 cm. Injection conduit 108 is inserted into petroleum field 112 through earth crust 110. In some cases, injection conduit 108 is attached to a coupling located on the ocean floor, which fluidically couples injection conduit 108 to a conduit that is inserted into petroleum field 112. Injection conduit 108 enables pumps on drilling platform 102 to force water 122 into petroleum field to facilitate the extraction of petroleum product 124 through extraction conduit 114.

Extraction conduit 114 is also a long metal pipe that typically has a diameter within the range of 10 centimeters (cm) to 30 cm. Extraction conduit 114 is attached to high-pressure, high-temperature (HPHT) well head 116, which fluidically couples extraction conduit 114 to conduit 118. Conduit 118 is inserted into petroleum field 112 through earth crust 110.

As oil processing moves to deeper undersea reservoirs, the temperature and pressure of petroleum products at HPHT well heads can exceed 150° C. and 500 bars, respectively. At such extreme temperatures and pressures, petroleum products become highly corrosive. As a result, injection conduit 108 and extraction conduit 114 comprise exotic, corrosive-resistant materials, such as duplex stainless steel, 625 corrosion-resistant alloy, and the like. These materials are expensive; therefore, the installation cost for pipeline of a single well can become very expensive, thereby making the installation of a new platform prohibitive.

In addition to high installation costs, the operating costs associated with powering subsea pumps, surface-based diesel generators, power cabling, etc., further diminish the cost-effectiveness of deep-sea petroleum production facilities. Further, the power system 104 generates a number of pollutants and has the potential for leaking fuel into the surrounding environment. Still further, power system 104 represents a significant reliability issue for system 100.

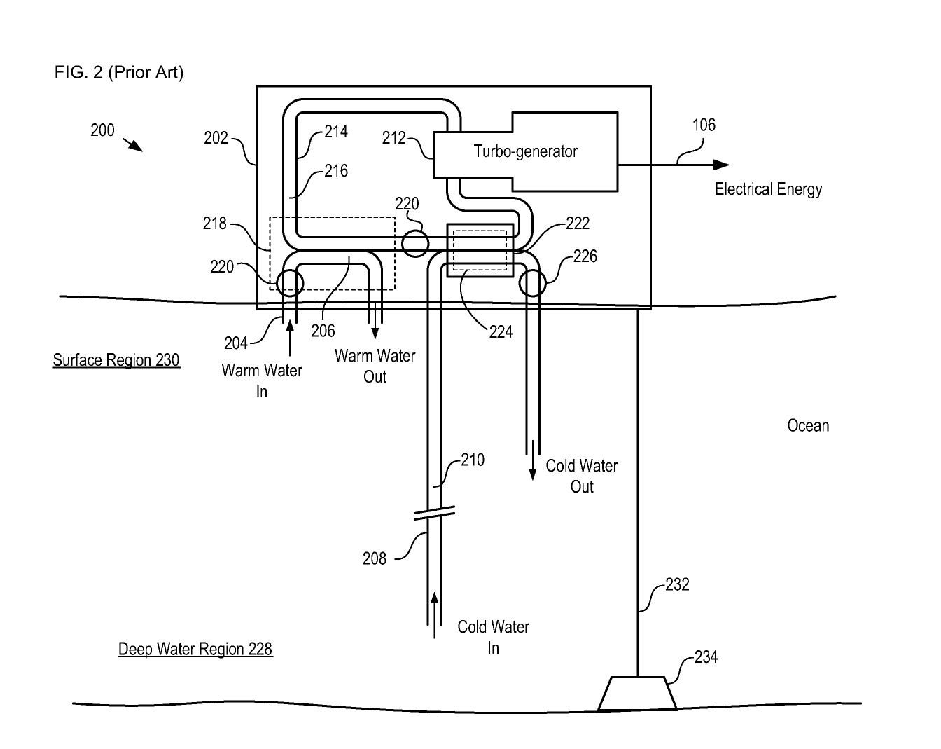

FIG. 2 depicts a schematic diagram of a portion of a representative OTEC power generation system in accordance with the prior art. OTEC system 200 comprises platform 202, surface water conduit 204, deep water conduit 208, turbogenerator 212, closed-loop conduit 214, heat exchanger 218, pump 220, and condenser 222. OTEC systems are more “environmentally friendly” than comparable petrochemical-based power generation systems; however, OTEC systems are typically less efficient.

Platform 202 is a conventional floating energy-plant platform. Platform 202 is anchored to the ocean floor by mooring line 232, which is connected to anchor 234. Anchor 234 is embedded in the ocean floor. In some instances, platform 202 is not anchored to the ocean floor and platform 202 is allowed to drift. Such a system is sometimes referred to as a “grazing plant.”

Surface water conduit 204 is a large-diameter conduit suitable for pumping surface water 206 from surface region 230 into heat exchanger 218. Pump 220 pumps surface water 206 through surface water conduit 204.

Closed-loop conduit 214 is a closed-circuit loop of conduit that contains working fluid 216. Ammonia is commonly used as a working fluid; however, many other fluids are known to be suitable for use as working fluid 216.

Closed-loop conduit 214 and surface water conduit 204 are thermally coupled at heat exchanger 218. As a result, working fluid 216 and surface water 206 are also thermally coupled at heat exchanger 218. This enables the heat of surface water 206 to vaporize the working fluid 216. The expanding vapor turns turbogenerator 212, which generates electrical energy. The generated electrical energy is provided on output cable 106.

After passing through turbogenerator 212, the vaporized working fluid enters condenser 222, which comprises heat exchanger 224. At heat exchanger 224, closed-loop conduit 214 and deep water conduit 208 are thermally coupled, which enables the thermal coupling of the vaporized working fluid 216 and cold water 210. Cold water 210 is drawn into condenser 222 from deep water region 228 by pump 226. Typically deep water region 228 is 1000+ meters below the surface of the body of water. Water at this depth is at a substantially constant temperature of a few degrees centigrade.

Cold water 210 acts as a heat sink for vaporized working fluid 216 at heat exchanger 224. As a result, vaporized working fluid 216 is cooled by cold water 210 and condenses back into its liquid state. Pump 220 then recycles the condensed working fluid back into heat exchanger 218 where it is vaporized again to continue the cycle that drives turbogenerator 212.

Conventional OTEC systems have several drawbacks. First, it is difficult and energy intensive to pump cold water up from depths of 1000+ meters. This challenge is further exacerbated by the fact that cold water is denser than warm water, which increases the energy required to draw it up to the surface. This significantly reduces the benefits of using an OTEC approach for power generation.

Second, deep water conduit 208 is typically at least 10 meters in diameter and 1000+ meters long. Such a conduit is difficult and expensive to manufacture.

Third, the size and length of deep water conduits makes them susceptible to damage from environmental conditions, such as strong currents, storms, and wave action. As a result, complicated and expensive infrastructure is required to protect these conduits from damage. For example, numerous recent efforts have been made to improve the reliability of cold water conduits. These include the development of flexible conduits, inflatable conduits, rigid conduits made from steel, plastics, and composites, and gimbal-mounted conduits. Even with such proposed innovations, long cold water conduits remain a significant reliability and cost issue.

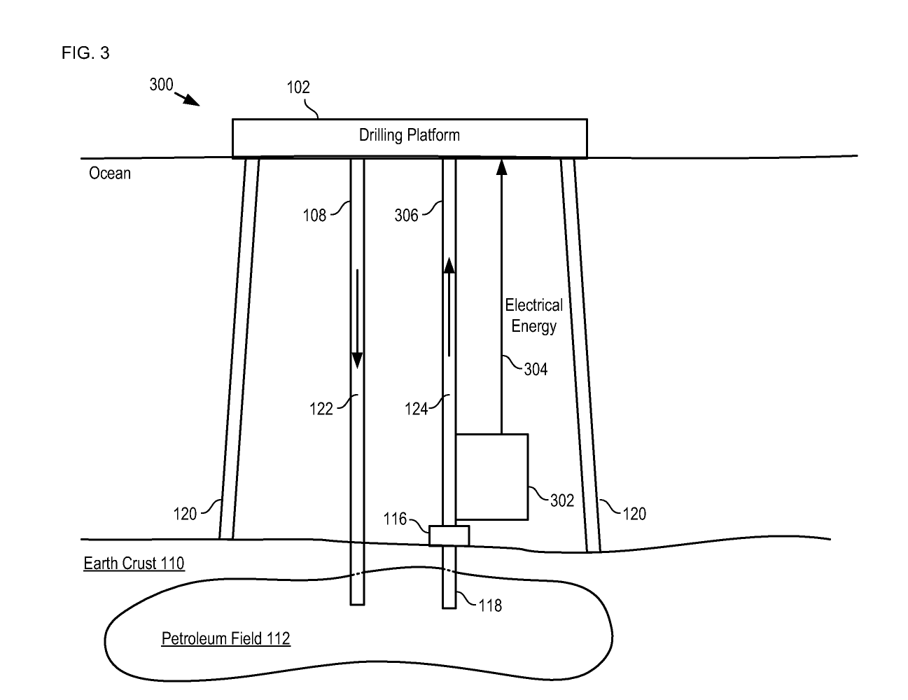

FIG. 3 depicts a schematic diagram of details of an off-shore petroleum production system in accordance with an illustrative embodiment of the present invention. System 300 comprises tension-leg platform 102, injection conduit 108, extraction conduit 306, well head 116, and energy conversion system 302. Although system 300 comprises a tension-leg platform, it will be clear to one skilled in the art, after reading this specification, how to specify, make, and use alternative embodiments of the present invention comprising platforms that are other than tension-leg platforms, including, without limitation, floating platforms, grazing platforms, compliant tower platforms, fixed platforms, and SPAR platforms.

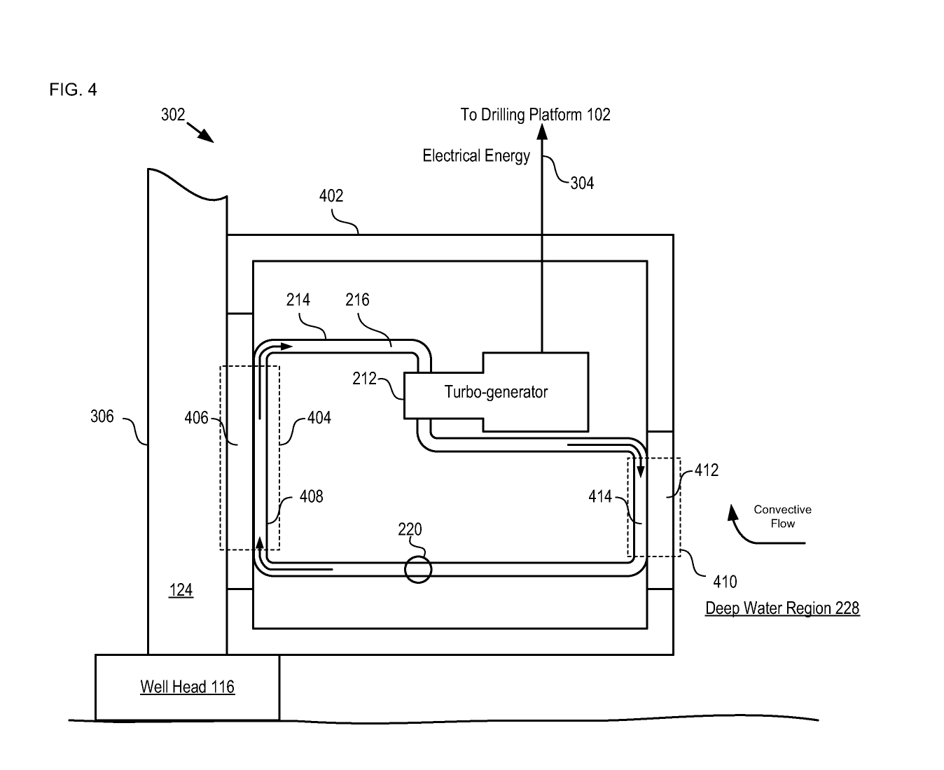

FIG. 4 depicts a schematic diagram of details of energy conversion system 302. Energy conversion system 302 is a Rankine-cycle energy conversion system. Energy conversion system 302 comprises turbo-generator 212, closed-loop conduit 214, pump 220, pressure hull 402, heat exchanger 404, and heat exchanger 410. Energy conversion system 302 is physically connected and thermally coupled with extraction conduit 306 just above well head 116. In some embodiments, energy conversion system 302 is physically connected and thermally coupled to well head 116.

Pressure hull 402 is a shell of structural material having sufficient mechanical strength to withstand the pressures that exist at deep water levels. The specific design of pressure hull 402 is based upon the intended application and deployment depth. For example, a pressure hull intended to be deployed at a depth of 1000 meters must be able to withstand water pressure that exceeds 100 atmospheres. In addition, pressure hull 402 comprises an electrical feed-through to enable generated electrical energy to be conveyed on cable 304.

Pressure hull 402 comprises hot zone 406 and cold zone 412. Hot zone 406 is a portion of heat exchanger 404. Cold zone 412 is a portion of heat exchanger 410. Hot zone 406 and cold zone 412 comprise structural material that is substantially thermally conductive. The remainder of pressure hull 402 comprises structural material that is less thermally conductive than the material of hot zone 406 and cold zone 412. In some embodiments, the entirety of pressure hull 402 is formed of thermally conductive material.

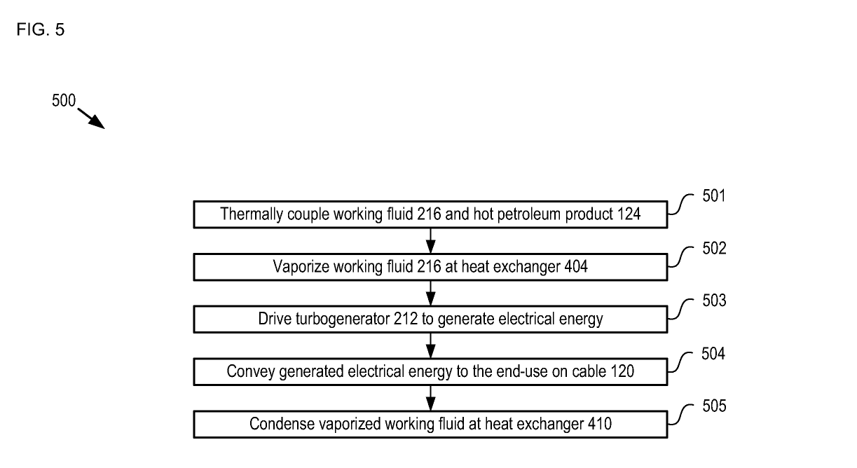

FIG. 5 depicts a method for powering an off-shore petroleum production system in accordance with the illustrative embodiment of the present invention. Method 500 is described herein with continuing reference to FIGS. 3 and 4.

Method 500 begins with operation 501, wherein working fluid 216 and hot petroleum product 124 are thermally coupled at heat exchanger 404. Heat exchanger 404 comprises conduit section 408 and hot zone 406. Hot zone 406 is thermally coupled with a portion of extraction conduit 306, which enables the transfer of heat from petroleum product 124 to working fluid 216 through hot zone 406 and conduit section 408.

At operation 502, working fluid 216 absorbs heat from hot petroleum product 124. The exchange of heat from petroleum product 124 to working fluid 216 vaporizes the working fluid. In addition, the loss of some of its heat to working fluid 216 cools petroleum product 124. Because the temperature of petroleum product 124 is lower, extraction conduit 306 can comprise conventional subsea piping materials, rather than exotic corrosion resistant materials required by prior-art HPHT systems.

At operation 503, turbogenerator 212 is driven by the high-pressure vaporized working fluid 216. As a result, turbogenerator 212 generates electrical energy.

At operation 504, the generated electrical energy is conveyed to platform 102 on power cable 304.

At operation 505, the vaporized working fluid 216 is thermally coupled with cold water from deep water region 228. As a result, vaporized working fluid 216 gives off some of its heat and condenses back into liquid form at heat exchanger 410. Heat exchanger 410 comprises conduit section 414 and cold zone 412, which is a section of pressure hull 402.

Cold zone 412 conveys heat from conduit section 414 to cold water outside pressure hull 402. As the water outside the pressure hull absorbs this heat, it rises and is replaced by cold water from the surrounding region. As a result, a natural convective flow of water across cold zone 412 commences. In some embodiments, the convective flow of cold water across cold zone 412 is constrained by an optional chimney, thereby increasing the heat flow through the heat exchanger and into the cold water.

Pump 220 pumps the condensed working fluid 216 back to heat exchanger 404.

In some embodiments, pump 220 is not included in energy conversion system 302, since the flow of working fluid 216 occurs as a consequence of a convective flow around closed-loop conduit 214 (clockwise, as depicted in FIG. 4). As working fluid 216 gains heat and vaporizes at heat exchanger 404, the hot fluid rises. At heat exchanger 410, vaporized working fluid 216 is cooled and condenses and naturally descends down closed-loop conduit 214.

It is an aspect of the present invention that the water at a deep level of an ocean or similar body of water provides a heat sink with sufficient heat capacity to enable it to maintain a substantially constant temperature at all times. It is well-known that ocean temperatures drop with depth. For example, tropical and semi-tropical ocean temperatures at depths of 300, 500, and 1000 meters remain substantially constant at 12, 8, and 4° C., respectively. Deep water levels, therefore, have a heat-sink capability that is well-suited to the present invention.

The present invention affords several advantages over the prior-art. In a conventional HPHT petroleum production system, the temperature and pressure of petroleum products at HPHT well heads can exceed 150° C. and 500 bars, respectively. At such extreme temperatures and pressures, petroleum products are highly corrosive. By virtue of the heat exchange processes that occur between petroleum product 124, hot zone 406, and working fluid 216, the temperature of petroleum product 124 is reduced significantly. As a result, energy conversion system 300 can use conventional subsea piping materials as opposed to exotic corrosion resistant materials required for prior-art systems. Embodiments in accordance with the present invention, therefore, can have lower installation and maintenance costs.

Further, embodiments of the present invention do no require a long deep-water cold pipe, such as is required in a conventional OTEC system. As a result, installation costs are lowered and system reliability is improved.

Still further, the present invention enables a “green” source of energy for powering off-shore platforms. Since embodiments of the present invention obviate the need for petro-chemical-based power generators, their environmental impact is mitigated or eliminated. In addition to being more environmentally friendly than conventionally powered systems, this can also reduce the political reticence toward the deployment of off-shore energy platforms.

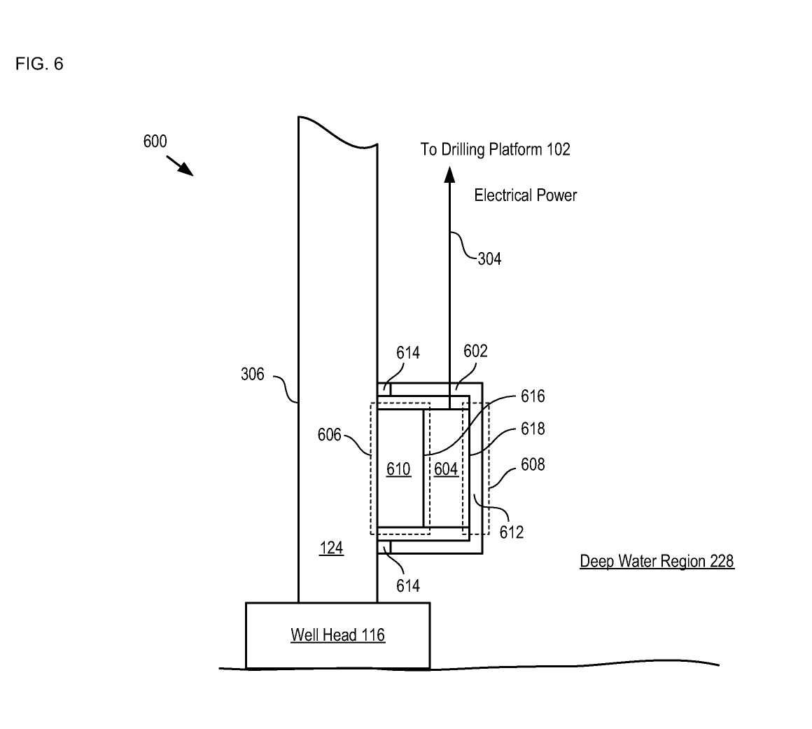

FIG. 6 depicts a schematic diagram of details of an energy conversion system in accordance with an alternative embodiment of the present invention. Energy conversion system 600 comprises pressure hull 602, thermoelectric element 604, and heat exchangers 606 and 608.

Thermoelectric element 604 is a solid-state thermoelectric device that generates electrical energy based on a temperature difference between surfaces 616 and 618. Thermoelectric element 604 comprises a bi-metallic couple (e.g. bismuth-telluride) that generates an open-circuit voltage in response to a thermal gradient placed across it. Commercial examples of thermoelectric element 604 include quantum-well modules available from Hi-Z Technology, Inc. In some embodiments, thermoelectric element 604 is a solid-state element that generates electrical energy by means of the Peltier effect.

Hot zone 610 is a thermally conductive plate suitable for conveying heat from extraction conduit 306 to surface 616 of thermoelectric element 604. Hot zone 610 and a portion of extraction conduit 306 collectively define heat exchanger 606. Heat exchanger 606 thermally couples petroleum product 124 and surface 616. In some cases, the material extracted from petroleum reserve 502 can reach temperatures of 150-200° C.

Cold zone 612 is a portion of pressure hull 602. Pressure hull 602 comprises structural material that is substantially thermally conductive. As a result, cold zone 612 acts as a heat exchanger that thermally couples a second surface of thermoelectric element 604 and cold water from deep water region 228. Pressure hull 602 is thermally insulated from extraction conduit 306 by optional thermal insulators 614.

In some embodiments, energy conversion unit 610 is a stand-alone unit that is completely encased by pressure hull 602, which attaches to extraction conduit 306 by means of a mechanical clamping system or magnetic clamping system. In some embodiments, a plurality of extraction conduits is used to increase the amount of electrical energy generated by electric conversion system 600. In order to enhance the heat exchange through cold zone 612 to the surrounding sea water, optional heat sink elements can be attached to pressure hull 602.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An apparatus for generating electrical energy comprising:
an energy conversion unit, wherein the energy conversion unit comprises;
a hot zone, wherein the hot zone and a conduit are thermally coupled; and
a cold zone that is thermally coupled to a region of a body of water; and
an energy conversion system that generates electrical energy based on a temperature difference between the hot zone and the cold zone;
wherein the conduit conveys a petroleum product from a petroleum reserve.

2. The apparatus of claim 1 wherein the region is at a depth greater than 100 meters.

3. The apparatus of claim 1 wherein the region is at a depth greater than 1000 meters.

4. The apparatus of claim 1 wherein the energy conversion system comprises a Rankine-cycle engine.

5. The apparatus of claim 1 wherein the energy conversion system comprises a solid-state thermoelectric element.

6. The apparatus of claim 1 wherein the energy conversion system generates electrical energy by means of the Peltier effect.

7. The apparatus of claim 1 wherein the energy conversion system comprises a quantum-well thermoelectric element.

8. The apparatus of claim 1 further comprising a pressure hull, and wherein the pressure hull encloses the energy conversion system.

9. The apparatus of claim 8 wherein the pressure hull comprises the cold zone.

10. An apparatus for generating electrical energy comprising:
a conduit, wherein the conduit conveys a fluid from a petroleum reserve;
an energy conversion unit, wherein the energy conversion unit comprises;
a hot zone that is thermally coupled to the fluid; and
a cold zone that is thermally coupled to a region of a body of water;
an energy conversion system that generates electrical energy based on a temperature difference between the hot zone and the cold zone.

11. The apparatus of claim 10 wherein the region is at a depth greater than 100 meters.

12. The apparatus of claim 10 wherein the region is at a depth greater than 1000 meters.

13. The apparatus of claim 10 wherein the energy conversion system comprises a Rankine-cycle engine.

14. The apparatus of claim 10 wherein the energy conversion system comprises a solid-state thermoelectric element.

15. The apparatus of claim 10 wherein the energy conversion system generates electrical energy by means of the Peltier effect.

16. The apparatus of claim 10 wherein the energy conversion system comprises a quantum-well thermoelectric element.

17. A method for generating electrical energy comprising:
conveying petroleum product from a petroleum reservoir;
thermally coupling a hot zone of an energy conversion unit to the conduit;
thermally coupling a cold zone of the energy conversion unit to a region of a body of water; and
generating electrical energy, wherein the energy conversion unit generates the electrical energy based on a temperature differential between the hot zone and the cold zone.

18. The method of claim 17 further comprising providing the generated electrical energy to a petroleum production platform.

19. The method of claim 17 further comprising:
thermally coupling the hot zone and a working fluid;
vaporizing the working fluid; and
condensing the working fluid;
wherein the turbogenerator generates the electrical energy based on a pressure that is based on the vaporized working fluid.

20. The method of claim 17 further comprising:
thermally coupling the hot zone and a first surface of a thermoelectric element;
thermally coupling the cold zone and a second surface of the thermoelectric element;
wherein the thermoelectric element generates the electrical energy based on a difference in the temperature of the first surface and the second surface.
